(19) United States
(12) Patent Application Publication
(10) Pub. No.: US 2024/0323320 A1
(43) Pub. Date: Sep. 26, 2024

(54) SECURE VIRTUAL MEETING VAULTS TO PROTECT USER PRIVACY

(71) Applicant: International Business Machines Corporation, Armonk, NY (US)

(72) Inventor: Anthony Butler, Riyadh (SA)

(21) Appl. No.: 18/124,512

(22) Filed: Mar. 21, 2023

(51) Int. Cl. H04N 7/15; G06F 3/01; H04L 9/32; H04N 7/14

(52) U.S. Cl. CPC H04N 7/157; G06F 3/013; H04L 9/3263; H04N 7/147; H04N 7/152; H04N 7/155

(57) ABSTRACT

A computer-implemented method, according to one embodiment, includes receiving, from a first user device associated with a first user in a shared virtual world, a request to create a secure virtual meeting vault. In response to receiving the request, the secure virtual meeting vault is created. The secure virtual meeting vault runs on a secured container computing environment that is separate from the shared virtual world. The method further includes teleporting an avatar representing a first user in the shared virtual world to the secure virtual meeting vault. In response to a determination that an event within the secure virtual meeting vault has concluded, the secure virtual meeting vault is verifiably destroyed. A computer program product, according to another embodiment, includes a computer readable storage medium having program instructions embodied therewith. The program instructions are readable and/or executable by a computer to cause the computer to perform the foregoing method.

### BACKGROUND

The present invention relates to virtual reality, and more specifically, this invention relates to creating and managing the use of a secure virtual meeting vault that runs on a secured container computing environment that is separate from a shared virtual world to protect user privacy.

Virtual reality (VR) is a three-dimensional, computer-generated environment which can be explored and interacted with by a person. This person becomes part of a virtual world and/or is immersed within this environment and whilst there, is able to manipulate objects and/or perform a series of actions.

One VR-based computer-generated environment includes a shared virtual world such as the “metaverse.” A shared virtual world is an immersive hypothetical virtual world that users experience and explore by utilizing user devices. These user devices may include, e.g., a VR headset, an augmented reality (AR) headset, VR glasses, VR rooms that include a plurality of display walls, etc. Within a shared virtual world, users are able to interact with other users, e.g., virtually meet, converse, perform virtual activities, collaborate, etc.

### SUMMARY

A computer-implemented method, according to one embodiment, includes receiving, from a first user device associated with a first user in a shared virtual world, a request to create a secure virtual meeting vault. In response to receiving the request, the secure virtual meeting vault is created. The secure virtual meeting vault runs on a secured container computing environment that is separate from the shared virtual world. The method further includes teleporting an avatar representing a first user in the shared virtual world to the secure virtual meeting vault. In response to a determination that an event within the secure virtual meeting vault has concluded, the secure virtual meeting vault is verifiably destroyed.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the method of FIG. 2A, in accordance with one embodiment of the present invention.

FIG. 3 is a flowchart of a method, in accordance with one embodiment of the present invention.

FIG. 4 is a representation of an environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for creating and managing the use of a secure virtual meeting vault that runs on a secured container computing environment that is separate from a shared virtual world to protect user privacy.

In one general embodiment, a computer-implemented method includes receiving, from a first user device associated with a first user in a shared virtual world, a request to create a secure virtual meeting vault. In response to receiving the request, the secure virtual meeting vault is created. The secure virtual meeting vault runs on a secured container computing environment that is separate from the shared virtual world. The method further includes teleporting an avatar representing a first user in the shared virtual world to the secure virtual meeting vault. In response to a determination that an event within the secure virtual meeting vault has concluded, the secure virtual meeting vault is verifiably destroyed.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as secure virtual meeting vault management code of block 150 for creating and managing the use of a secure virtual meeting vault that runs on a secured container computing environment that is separate from a shared virtual world to protect user privacy. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

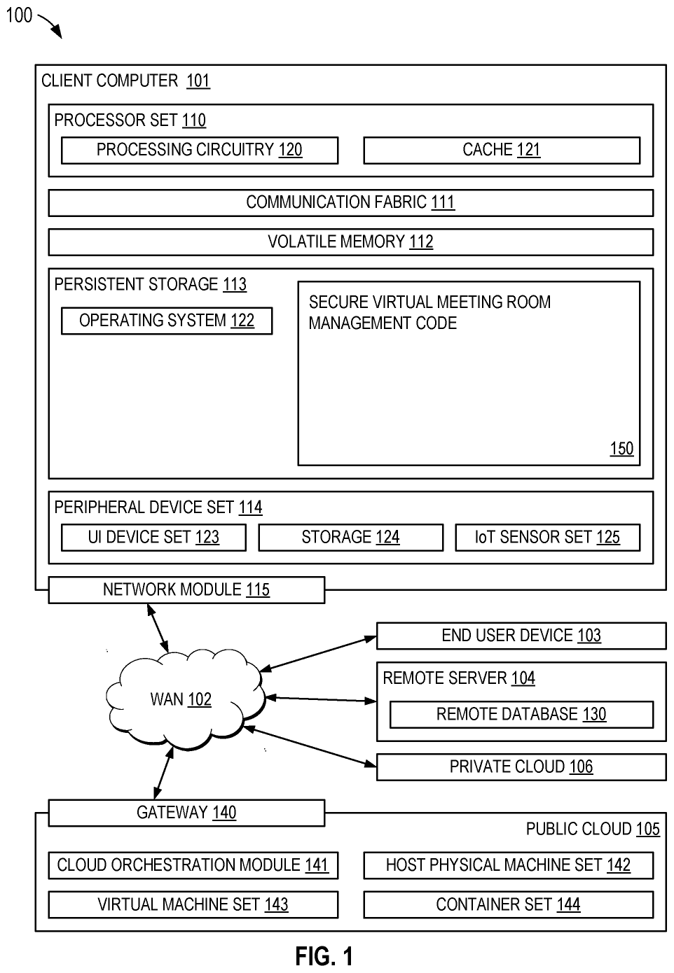

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, virtual reality (VR) is a three-dimensional, computer-generated environment which can be explored and interacted with by a person. This person becomes part of a virtual world and/or is immersed within this environment and whilst there, is able to manipulate objects and/or perform a series of actions.

One VR-based computer-generated environment includes a shared virtual world such as the “metaverse.” A shared virtual world is an immersive hypothetical virtual world that users experience and explore by utilizing user devices. These user devices may include, e.g., a VR headset, an augmented reality (AR) headset, VR glasses, VR rooms that include a plurality of display walls, etc. Within a shared virtual world, users are able to interact with other users, e.g., virtually meet, converse, perform virtual activities, collaborate, etc.

There are a broad range of emergent challenges and threats related to privacy in shared virtual worlds such as the metaverse. Many of these challenges and threats relate to privileged access that the infrastructure providers have, including the provider of the shared virtual world platform itself. These platforms can, for example, listen to conversations between avatars, track movements of the avatars, and therein gain relatively extensive insights that have the potential for being exploited for commercial or other more nefarious purposes, such as blackmail or extortion. There are also emergent threats from other participants in the field of shared virtual worlds which may, for example, take advantage of vulnerabilities to eavesdrop on conversations between avatars. Furthermore, these threats have a potential for, depending on the platform, hiding or otherwise residing in a proximity of participants in order to eavesdrop. These challenges and threats ultimately contribute to customer dissatisfaction and distrust of shared virtual worlds. Furthermore, a relatively significant amount of computer processing and finances are expended in recovering from successful unauthorized eavesdropping events, e.g., troubleshooting, implementing security measures, etc. Accordingly, there is a need within the field of virtual reality to ensure that communications between at least some users remain private and secure.

In sharp contrast to the deficiencies of the conventional techniques described above, the techniques of embodiments and approaches described herein address the challenge of how to secure interactions within shared virtual worlds both in terms of avoiding eavesdropping and surveillance, and also in terms of ensuring that agreements or discussions can be contractually enforced via some sort of immutable recording of the agreement. The novel techniques described herein facilitate this by enabling the creation of secure privacy-preserving “vaults” that run in secure and/or trusted execution environments (TEEs) outside of the shared virtual world platform while being integrated with the shared virtual world such that a user can teleport into a “secure virtual meeting vault” and experience a similar virtual world to the normal metaverse environment albeit with the difference that the vault has certain privacy features. It should be noted that conventional mechanisms fail to address the deficiencies of the conventional techniques described above. It should also be noted that otherwise engaging in a discussion/agreement using some alternative offline channel, such as via encrypted chat or some other mechanism that is peer to peer does not address the challenges and threats related to privacy in shared virtual worlds described elsewhere above. This is because these techniques ultimately break the experience of the metaverse and require a user to exit entirely. More concerning, data leakages, e.g., such as disclosing a person's true identity or similar issues, are known to occur as a result of these users having to switch to the alternative offline channel.

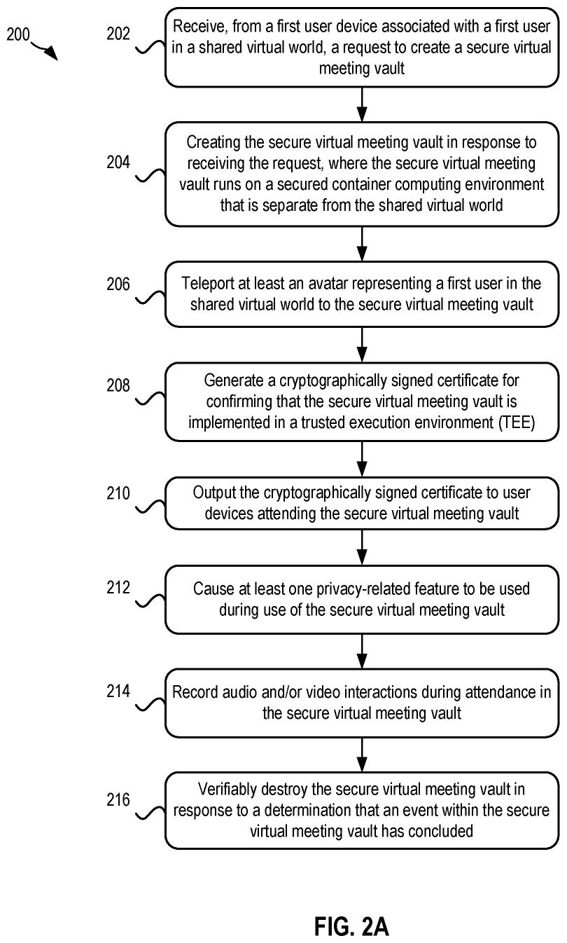

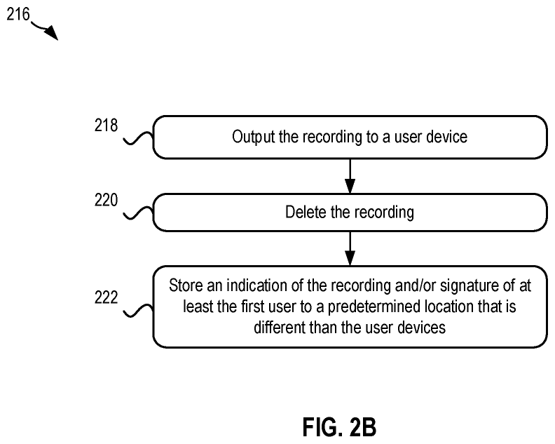

Now referring to FIG. 2A, a flowchart of a method 200 is shown, according to one embodiment. The method 200 may be performed in accordance with the present invention in any of the environments depicted in FIGS. 1-4, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes receiving a request for creating a secure virtual meeting vault. The request may be received from a first user device associated with a first user in a shared virtual world. For example, during use of the first device to interact within the shared virtual world, the first user may want to hold a private meeting with at least one other user, e.g., a second user, a third user, a fourth user, etc. In some other approaches, the first user may wish to virtually enter a private and secure virtual setting in which the first user is able to perform an activity, e.g., talk on the phone, sing, whistle, practice a speech, etc., without having other users within the shared virtual world and/or an infrastructure provider of the shared virtual world being able to obtain, e.g., collect unknown to the first user, eavesdrop, mine, etc., information, such as audio, associated with the user during attendance in the private and secure virtual setting.

For context, the shared virtual world may be actively explored by a plurality of users, e.g., the first user, a second user, a third user, etc., using at least one user device associated with the user, e.g., a VR device, an AR device, a computer, VR glasses, etc. The shared virtual world may about resemble reality in some approaches, e.g., buildings, landmarks, a location preselected by a user entering the shared virtual world, etc. In some approaches, the users may additionally and/or alternatively be able to navigate the shared virtual world using, e.g., a controller, a walking treadmill, a stationary bicycle, etc. While interacting within the shared virtual world, one or more users are, in some approaches, enabled to interact with one another, e.g., chat, dance, play board games, drive in a car together, etc. Users may use user devices to initiate such interactions, e.g., walk up to other users, start an audible conversation with another user visible in the shared virtual world, output a discussion request, etc. Users interacting within the shared virtual world may each have an associated avatar. The avatar may, in some approaches, be based on an actual appearance of the user. In some other approaches, the avatar may not be based on an actual appearance of the user so as to maintain a privacy of the user while interacting within the shared virtual world. The avatars may be assigned to the users of the shared virtual world by the infrastructure provider of the shared virtual world, be randomly assigned to the users, be customizable by the users, etc.

In some approaches, the interactions between users may be visible and/or audibly heard by other users within the shared virtual world that are within a predetermined distance from the interacting users, e.g., within eyesight, within a predetermined audible range, within a predetermined location, etc. In some approaches, at least some users may want to have a private meeting and/or conversation, e.g., alone, with at least one other user shared virtual world, with a plurality of the users in the shared virtual world, etc. For context, in some approaches, “private” refers to at least an ability to not be overheard by other users in the shared virtual world that are not invited to the private meeting in addition to the infrastructure provider of the shared virtual world. Furthermore, in some approaches, “private” refers to at least an ability to not be overheard by unauthorized entities that have access to the shared virtual world, but that are not necessarily known to be navigating within the shared virtual world, e.g., malicious web crawlers, bot accounts, etc. In order to enable such a private meeting and thereby prevent information associated with the private meeting from being obtained by unauthorized people and/or entities, a secure virtual meeting vault may, in some approaches, be created in response to receiving the request for creating the secure virtual meeting vault.

Operation 204 includes creating the secure virtual meeting vault in response to receiving the request. For context, the secure virtual meeting vault may be a collaboration room that avatars of users who agree to participate in a private meeting in the secure virtual meeting vault are placed in and thereby enabled to engage in a discussion or other exchange with privacy of the interactions that occur in the secure virtual meeting vault being assured. In some preferred approaches, the secure virtual meeting vault runs on a secured container computing environment that is separate from the shared virtual world. For example, in some approaches, the secure virtual meeting vault is run separate from the shared virtual world in that the secure virtual meeting vault is implemented in a trusted execution environment (TEE). The TEE may, in some approaches, be a secure container. For context, as a result of ensuring that the secure virtual meeting vault runs on a secured container computing environment that is separate from the shared virtual world, the infrastructure and/or service that provides and maintains the shared virtual world is not able to access the secure virtual meeting vault. More specifically, the infrastructure and/or service, as well as users and/or entities that have access to the shared virtual world, are not able to obtain information associated with the shared virtual world, e.g., records of interactions that occur in the shared virtual world, configuration information associated with the shared virtual world, a virtual location that the shared virtual world at least temporarily exists in, hardware components that are used to create, maintain and/or destroy the shared virtual world, etc. Relatively more simply said, in some approaches, this means that any discussion(s) or other interactions that occur within the created secure virtual meeting vault are outside of the shared virtual world platform(s) itself and cannot be subject to eavesdropping or intercept.

In some approaches, creation of the secure virtual meeting vault includes providing optional predetermined parameters to the users in advance of the creation of the vault, e.g., for the users to optionally select. For example, the predetermined parameters may detail, e.g., security protocols and/or tests performed on the secure virtual meeting vault before allowing users access to the secure virtual meeting vault, types of firewalls deployed on the secure virtual meeting vault, response strategies to detected unauthorized user device attempts on the secure virtual meeting vault, types of user devices allowed to be used by users during interaction within the secure virtual meeting vault, etc. In some approaches, a directory that includes a plurality of potential secure virtual meeting vaults that each have different relative degrees of predetermined parameters may be provided to a user device that requests the creation of the secure virtual meeting vault to enable the user to select one of the potential secure virtual meeting vaults. A selection of the potential secure virtual meeting vaults may thereafter be received and used for creating the secure virtual meeting vault. In some approaches, in response to receiving a selection of the potential secure virtual meeting vaults from the first user device, at least some avatars associated with user devices that are to be allowed access to the secure virtual meeting vault are teleported from the shared virtual world to the secure virtual meeting vault, e.g., see operation 206. For example, an avatar representing the first user in the shared virtual world may be teleported to the secure virtual meeting vault, an avatar representing a second user in the shared virtual world that is invited by the first user device to interact in a private meeting may be teleported to the secure virtual meeting vault, etc.

In some approaches, one or more predetermined privacy features of the vault are enabled before avatars are teleported into the secure virtual meeting vault. In some other approaches, subsequent to at least one avatar being teleported to inside the secure virtual meeting vault, one or more predetermined privacy features of the secure virtual meeting vault may be enabled. Various predetermined privacy features of the secure virtual meeting vault are described below, according to some approaches.

In some preferred approaches, a predetermined privacy feature of the secure virtual meeting vault may include an assurance of the secure virtual meeting vault in fact being secure. This assurance may, in some approaches, be output for display on one or more user devices associated with avatars in the secure virtual meeting vault. For example, method 200 may, in some approaches, include causing a user device that is not authorized to access and/or interact within the secure virtual meeting vault to attempt to access and/or interact within the secure virtual meeting vault. Techniques that would become apparent to one of ordinary skill in the art upon reading the descriptions herein may be used to cause the unauthorized user device to perform such an attempt. A determination may be made that the secure virtual meeting vault is in fact secure in response to a determination that the user device that is not authorized to access and/or interact within the secure virtual meeting vault is not able to access and/or interact within the secure virtual meeting vault. In some approaches, in response to a determination that the secure virtual meeting vault is in fact secure, a certificate that indicates the confirmed secureness of the secure virtual meeting vault may be generated and output to one or more user devices associated with user participants of the private meeting in the secure virtual meeting vault. For example, operations 208 and 210 include generating and outputting a cryptographically signed certificate to the first user device for confirming that the secure virtual meeting vault is implemented in the TEE, e.g., such as a secure container that will be subsequently destroyed once parties exit the secure virtual meeting vault.

One or more other privacy-related features may additionally and/or alternatively be caused to be used during use of the secure virtual meeting vault, e.g., see operation 212. In one approach, causing at least one privacy-related feature to be used during use of the secure virtual meeting vault includes implementing a privacy-related feature that includes detecting and disabling a component of a user device allowed to access the secure virtual meeting vault. In some approaches, such a privacy-related feature may be enabled and become a differentiation for providers of secure virtual meeting vaults. For example, the privacy-related feature may disable an ability of users associated with avatars in the secure virtual meeting vault to record audio and/or video and/or chat of the interactions via predetermined user devices, e.g., a headset. For example, in order to ensure that such recording features of user devices are disabled, a microphone of at least one user device may be caused by an instruction to be disabled, a camera of at least one user device may be caused by an instruction to be disabled, etc. The privacy-related feature may, in some approaches, additionally and/or alternatively incorporate other features of a user device such as a headset that is used to experience the secure virtual meeting vault. Furthermore, the privacy-related feature may, in some approaches, additionally and/or alternatively include monitoring eye movements, facial features to determine and ensure that there has not been a change in the user that is using the user device to interact with other users in the secure virtual meeting vault. For example, eye movements of the first user may be monitored to ensure that only the first user is using the first user device. For context, by monitoring such user features, a user that is not authorized and/or known by other users in the secure virtual meeting vault is excluded from interacting in the secure virtual meeting vault.

In yet another approach, a recognition technique that would become apparent to one of ordinary skill in the art upon reading the descriptions herein may be used for ensuing that an unauthorized device is not being used by a user associated with a device that is allowed access to the secure virtual meeting vault. For example, although the first user may be enabled to interact within the secure virtual meeting vault, as a result of the first user device being allowed access to the secure virtual meeting vault, in some approaches, it may be ensured that the first user is not using some sort of unauthorized recording device, e.g., holding a recording device in front of the lens of the headset. In some approaches, method 200 includes kicking a user device from the secure virtual meeting vault in response to a determination that an unauthorized microphone is being used by the first user device and/or used by a user in the secure virtual meeting vault. For context, “kicking” the user device may refer to, e.g., a temporary ban on the user device, a permanent ban on the user device, the user device being labeled as untrustworthy until it is determined that the user device is not associated with such untrustworthy actions for at least a predetermined amount of time, etc.

Operation 214 includes recording audio and/or video interactions between at least the first user and a second user during attendance in the secure virtual meeting vault. More specifically, interactions such as a discussion conducted within the secure virtual meeting vault, may optionally, be recorded as an immutable record or agreement established in the secure virtual meeting vault. For context, the “agreement” may be enacted by outputting a condition that users allowed to interact within the secure virtual meeting vault must sign before their associated avatars are teleported into the secure virtual meeting vault. In some approaches, the agreement may specify that interactions within the secure virtual meeting vault are recorded. In some other approaches, the agreement may additionally and/or alternatively specify that any user electing to have their avatar teleported into the secure virtual meeting vault agrees to maintain a confidentiality contract thereafter, e.g., a non-disclosure agreement for the interactions that occur between users in the secure virtual meeting vault. A recording of a full interaction within the secure virtual meeting vault may, in some approaches, be made, and a digital signature may also be created for the recording based on the authorized parties participating in a discussion in the secure virtual meeting vault.

In some approaches, audio and/or video interactions during attendance in the secure virtual meeting vault may, in some approaches, be recorded. For example, the recordings may be a signature recorded to a blockchain so as to provide an immutable and third-party verifiable proof of the interactions that occurred in the secure virtual meeting vault and/or agreements made during such interactions. In some other approaches, a known predetermined other type of mechanism for recording such an agreement may be used. Note that recording information associated with interactions performed in the secure virtual meeting vault to blockchain is described in greater detail elsewhere below, e.g., see operation 216.

It should be noted that all monitoring or recording of users and/or user devices and/or user information described herein is preferably only performed subsequent to gaining expressed permission to do so from the user, e.g., an opt-in condition. More specifically, this permission is preferably obtained in such a way that the user has the opportunity to consider and review details of how their information will be used and/or the extent to which and when the monitoring is performed (to assist the user in making an informed decision). The user may thereafter be presented with an option to opt-in, e.g., an expressly performed opt-in selection. Thereafter, the user is, in some approaches, preferably reminded of their opt-in selection, and ongoingly presented with features, e.g., output for display on a user device associated with the user, that relatively easily allow the user to retract their previous election to opt-in. Note that these features may be presented to the user in any one or more formats, e.g., audibly, visually, braille, in multiple languages, etc. For example, the user may be presented with an unambiguous opt-out selection feature which, if elected by the user, terminates the collection and use of data associated with the user and/or monitoring of the user, erases previously used data associated with the user, and notifies the user of the course of action taken to respect the user's selection of the opt-out selection feature. In the event that the user does not want to have their data used in one or more of the operations described herein, this decision is respected, and the user is preferably not again presented with such an option unless the user thereafter requests to reconsider the opt-in feature, e.g., based on a change in their decision.

While interacting within the secure virtual meeting vault, a meeting environment may be displayed on the user devices for users authorized to access the secure virtual meeting vault. For example, in the meeting environment, users may see visuals and/or hear audio associated with the avatars of the users authorized to access the secure virtual meeting vault. The meeting environment may, in some approaches, additionally and/or alternatively include a room with transparent glass such that users in the secure virtual meeting vault may look through the transparent glass of the room to a representation of at least a portion of the shared virtual world. However, it should be noted again that, the secure virtual meeting vault runs on the secured container computing environment that is separate from the shared virtual world. The meeting environment may, in some approaches, additionally and/or alternatively include a conference room. Such a room may, in some approaches, include features specified in a survey output to user devices associated with users authorized to access the secure virtual meeting vault before the creation of the secure virtual meeting vault. Voting results for such contents may be received from the user described and are thereafter included in the creation of the secure virtual meeting vault.

For at least a portion of a duration that the avatars of some of the users exist in the secure virtual meeting vault, at least some of the avatars may, in some approaches, also reside in the shared virtual world. For example, the avatar representing a first user may remain visible in the shared virtual world while also present in the secure virtual meeting vault. However, it should be noted that a primary concept of the techniques described herein ensures that audio interactions between users, e.g., at least the first user and a second user, during attendance in the secure virtual meeting vault is not provided to a platform that deploys, e.g., maintains, hosts, etc., the shared virtual world to thereby prevent eavesdropping on conversations conducted in the secure virtual meeting vault. This ensures that the user's privacy is protected, and user data is not compromised as a result of eavesdropping events and/or the platform deploying the shared virtual world utilizing user data without permission to do so. In some approaches, method 200 includes outputting, to the platform that deploys the shared virtual world, a visual indication for incorporation in the shared virtual world to indicate that one or more of the users, e.g., the first user, are interacting in the secure virtual meeting vault. For example, avatars of the users that are interacting in the secure virtual meeting vault may be caused, e.g., instructed, to be grouped in a visual bubble, e.g., a visual “cone of silence”. In another approach, the avatars in the shared virtual world may be caused to emit predetermined muffled audio samples, e.g., mumbling, a song, a predetermined sentence, etc., to indicate that the users associated with the avatars are currently interacting outside of the shared virtual world in the secure virtual meeting vault.

Operation 216 includes verifiably destroying the secure virtual meeting vault in response to a determination that an event, e.g., interactions, discussions, a meeting time, etc., within the secure virtual meeting vault has concluded. The determination of whether the event within the secure virtual meeting vault has concluded may be based on one or more predetermined factors. For example, in one approach, natural language processing (NLP) may be performed on audio and/or text associated with interactions that occur in the secure virtual meeting vault. In one or more of such approaches, predetermined keywords may be monitored for and identified in order to determine that the event is or has concluded, e.g., “talk to you later”, “goodbye”, “signing off”, “end call”, “close the vault”, “destroy the vault”, etc.

Looking to FIG. 2B, exemplary sub-operations of verifiably destroying the secure virtual meeting vault are illustrated in accordance with various embodiments, one or more of which may be used to perform operation 216 of FIG. 2A. However, it should be noted that the sub-operations of FIG. 2B are illustrated in accordance with various embodiments which are in no way intended to limit the invention. Sub-operation 218 includes outputting the recording to a user device. For example, assuming that at least the first user uses the first user device to interact in the secure virtual meeting vault and the second user uses the second user device to interact in the secure virtual meeting vault, the recording may be output to the user device(s) associated with at least some of the users. The recording may, in some approaches, be output in an encrypted form. In such an approach, the user devices may obtain the encryption key for decrypting the encrypted recording during the interactions in the secure virtual meeting vault and before the secure virtual meeting vault is destroyed.

Operation 220 includes deleting the recording. Deleting the recording may, in some approaches, include causing a data storage component in which the recording is temporarily saved to be physically destroyed. In some other approaches, deleting the recording may additionally and/or alternatively include causing the recording to be overwritten in the data storage component in which the recording is temporarily saved. In yet another approach, deleting the recording may additionally and/or alternatively include scheduling blocks of storage space in which the recording is temporarily saved to be scheduled for a predetermined reclamation process, e.g., setting a reclamation flag that is associated with the storage space.

Operation 222 includes storing an indication of the recording and/or signatures of the users, e.g., at least the first user and the second user, to a predetermined location that is different than the user devices. In some preferred approaches, the predetermined location is a blockchain. Subsequent to storing the indication on the blockchain, a ledger of the blockchain may be distributed to only devices that were authorized to access the secure virtual meeting vault before it was verifiably destroyed, e.g., the first user device and the second user device. In some approaches, the indication includes information that does not identify an identity of the user devices and/or the users that were authorized to access the secure virtual meeting vault before it was verifiably destroyed, e.g., timestamp information. In some other approaches, the indication may additionally and/or alternatively include an encrypted copy, or an encrypted actual copy, of the contractual agreement. In some approaches, the identities associated with the agreement may optionally be redacted, but may also be revealed in response to a determination that one or more of the users in the event makes a claim against one of the other users to enforce the agreement.

With reference again to FIG. 2A, in response to a determination that the users have left the secure virtual meeting vault, proof of destruction of the container and/or the secure virtual meeting vault may be output to user devices associated with the users. This proof may, in some approaches, include details, e.g., a ledger, that can be used to legally enforced agreements entered into during interactions in the secure virtual meeting vault. A summary detailing what the users agreed to record and/or the agreement and/or activities that occurred in the secure virtual meeting vault may also be provided to the user devices. In some approaches, a record of such agreements and/or contents may be shared and cryptographically signed, if not done so already. The record could then be destroyed or stored in some form as specified in the agreement of the users that interacted in the secure virtual meeting vault.

Some use-case deployments of the techniques of method 200, may include multiple secure virtual meeting vault providers offering different features and levels of security and privacy. These vault providers may charge and/or monetize use of their services according to the different offerings of their associated secure virtual meeting vault.

Various benefits are enabled as a result of implementing the techniques described herein in shared virtual worlds. For example, the challenges and threats related to privacy in shared virtual worlds described elsewhere above are mitigated using the techniques described herein, e.g., see method 200. Furthermore, user information is prevented form being exploited by infrastructure providers of shared virtual worlds. It should be noted that a human cannot otherwise be ensured or trusted with absolute certainty to not exploit user information, and therefore the inventive discoveries disclosed herein with regards to use of secure virtual meeting vaults proceed contrary to conventional wisdom. Accordingly, these techniques mitigate the challenges and threats that would otherwise ultimately contribute to customer dissatisfaction, distrust of shared virtual worlds, significant amount of computer processing and finances that are expended in recovering from successful unauthorized eavesdropping events, etc., and thereby affordably improve performance of the computer devices of the infrastructure of shared virtual worlds.

In some approaches, a predetermined artificial intelligence (AI) model may be trained to perform one or more operations described herein, e.g., see method 200. In some approaches, the AI model may first be trained to recognize requests and/or propose the creation of secure virtual meeting vaults. Thereafter the predetermined AI model may be trained to create and verifiably destroy the secure virtual meeting vaults. One or more of these approaches may include training the AI model using a predetermined training set of data. For example, a predetermined training data set may be applied to an initial and untrained version of the AI model with an instruction that the initial and untrained version of the AI model is to attempt to determine when to destroy secure virtual meeting vaults, create secure virtual meeting vaults and teleport avatars therein, etc. Initial training may include reward feedback that may, in some approaches, be implemented using a subject matter expert (SME) who has access to known answers for the predetermined training set of data, e.g., such as context of interactions that should cause a secure virtual meeting vault to be created or destroyed. However, to prevent costs associated with relying on manual actions of a SME, in another approach, reward feedback may be implemented using techniques for training a Bidirectional Encoder Representations (BERT) model, as would become apparent to one skilled in the art after reading the present disclosure. Once a determination is made that the AI model has achieved a redeemed threshold of accuracy of deriving data access privilege grants during this training, a decision that the model is trained and ready to deploy for performing techniques and/or operations of method 200 may be performed. In some further approaches, the AI model may be a neuromyotonic AI model that may improve performance of computer devices in an infrastructure associated with the operations described herein, e.g., such as the infrastructure of the shared virtual world and/or infrastructure of the TEE, because the AI model may not need a SME and/or iteratively applied training with reward feedback in order to accurately perform operations described herein. Instead, the neuromyotonic AI model is configured to itself make determinations described in operations herein.

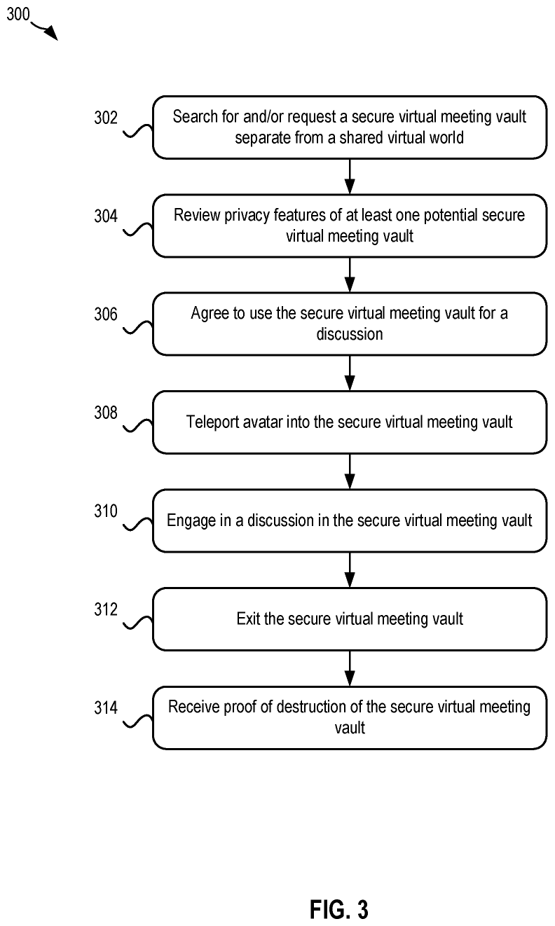

Now referring to FIG. 3, a flowchart of a method 300 is shown, according to one embodiment. The method 300 may be performed in accordance with the present invention in any of the environments depicted in FIGS. 1-4, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by the computer, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Method 300 illustrates a use case of two or more individuals, e.g., users, in a shared virtual world engaging and deciding to move to a secure virtual meeting vault, which may be created based on user devices associated with the users requesting creation of the secure virtual meeting vault. In some approaches, the users may want to move to such a secure virtual meeting vault because they want to record their conversation in an immutable and legally enforceable way. In another approach, the users may want to move to such a secure virtual meeting vault because they want to ensure that their conversation is not heard by other users and/or a supporting infrastructure of the shared virtual world. Accordingly, in some approaches, a plurality of potential secure virtual meeting vaults may be available, e.g., in a directory, and the users may utilize user devices to search for and/or request a secure virtual meeting vault separate from a shared virtual world, e.g., see operation 302.

The users may review privacy features of at least one potential secure virtual meeting vault in the directory of secure virtual meeting vaults, e.g., see operation 304. For each vault, the users are provided different illustrated information including, e.g., the physical location (jurisdiction), the type of security, the mechanism for recording (if needed) such as blockchain, etc., and other metadata related to the secure virtual meeting vault. This information and/or metadata may be output to the user devices associated with the users.

The users may agree to use a particular secure virtual meeting vault and their avatars may be teleported to it, e.g., see operations 306-308. Prior to entering, the users may inspect the security of the secure virtual meeting vault and/or be provided with a certificate confirming the ensured security. Upon entering the secure virtual meeting vault, the secure virtual meeting vault is, as with the rest of the shared virtual world, a virtual environment in which the users are enabled to interact via an associated avatar, e.g., see operation 310. The secure virtual meeting vault may, in some approaches, resemble any number of physical spaces, such as an actual vault, an empty park, a “cone of silence,” etc.

Upon the users leaving the secure virtual meeting vault, e.g., see operation 312, the vault is destroyed within the trusted execution environment and proof is provided to the user parties of such destruction, e.g., see operation 314. This proof will be recorded as an immutable record on a ledger, such as a public blockchain, and may, in some approaches, be used to prove legally that the conversation was not recorded or was destroyed.

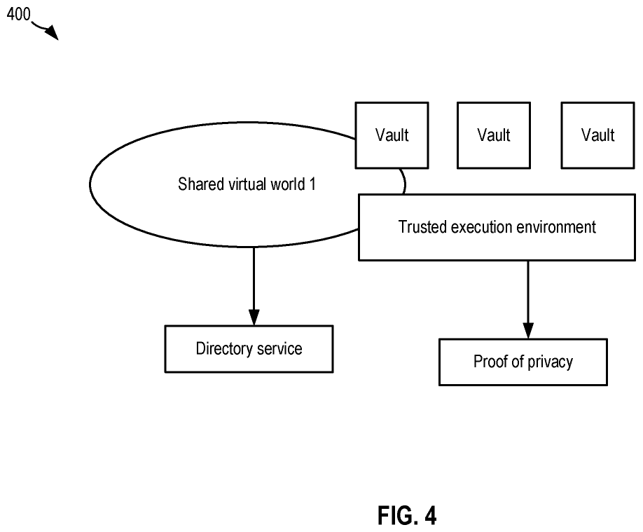

FIG. 4 depicts a representation 400 of an environment, in accordance with one embodiment. As an option, the present representation 400 may be implemented in conjunction with features from any other embodiment listed herein, such as those described with reference to the other FIGS. Of course, however, such representation 400 and others presented herein may be used in various applications and/or in permutations which may or may not be specifically described in the illustrative embodiments listed herein. Further, the representation 400 presented herein may be used in any desired environment.

Representation 400 illustrates an architecture in which operations described herein may be performed. A directory, e.g., see directory, contains a list of the different potential secure virtual meeting vault services. Each secure virtual meeting vault, e.g., see vault, is a secure platform that is adjacent to a shared virtual world, e.g., see shared virtual world. It should be noted that, in some approaches, the secure virtual meeting vault may be “integrated” with the shared virtual world in that avatars may be teleported from the shared virtual world to a created secure virtual meeting vault, and moreover, in some approaches, the avatars may remain depicted within the shared virtual world while users associated therewith are interacting in the secure virtual meeting vault. However, it should also be noted that a primary concept of the techniques described herein ensures that audio interactions between users, e.g., at least the first user and a second user, during attendance in the secure virtual meeting vault is not provided to a platform that deploys, e.g., maintains, hosts, etc., the shared virtual world to thereby prevent eavesdropping on conversations conducted in the secure virtual meeting vault. Accordingly, the secure virtual meeting vault may be run on a secured container computing environment that is thereby “separate” from the shared virtual world.

In some approaches, a single TEE, such as a secure container platform, may instantiate each created secure virtual meeting vault, e.g., see trusted execution environment. The secure virtual meeting vaults are virtual worlds into which an avatar associated with a person and the user's perspective while using an associated user device person are teleported to. Thereafter, upon the user and/or avatars exiting a secure virtual meeting vault, the secure virtual meeting vault is destroyed and, in some approaches, unless requested, no record of interactions in the secure virtual meeting vault is kept.

In some approaches, a service to record proof of destruction of the secure virtual meeting vault, e.g., such as a receipt, is enabled in an immutable form that can be used legally if needed, e.g., see proof of privacy. In some approaches, users within a secure virtual meeting vault may mutually agree to record the interaction so that such interactions may be legally enforced thereafter. In some approaches, this includes an actual recording of the interaction or some other agreement form, such as text, that is created in the secure virtual meeting vault and then signed cryptographically with a record stored on an immutable ledger.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, from a first user device associated with a first user in a shared virtual world, a request to create a secure virtual meeting vault;
in response to receiving the request, creating the secure virtual meeting vault, wherein the secure virtual meeting vault runs on a secured container computing environment that is separate from the shared virtual world;
teleporting an avatar representing a first user in the shared virtual world to the secure virtual meeting vault; and
in response to a determination that an event within the secure virtual meeting vault has concluded, verifiably destroying the secure virtual meeting vault.

2. The computer-implemented method of claim 1, comprising: recording audio and/or video interactions between at least the first user and a second user during attendance in the secure virtual meeting vault.

3. The computer-implemented method of claim 2, wherein verifiably destroying the secure virtual meeting vault includes: outputting the recording to a second user device associated with the second user, deleting the recording, and storing an indication of the recording and/or signatures of at least the first user and the second user to a predetermined location that is different than the user devices.

4. The computer-implemented method of claim 3, wherein the predetermined location is a blockchain, and comprising: distributing a ledger of the blockchain to only the first user device and the second user device.

5. The computer-implemented method of claim 1, wherein the secure virtual meeting vault is implemented in a trusted execution environment (TEE).

6. The computer-implemented method of claim 5, wherein the TEE is a secure container.

7. The computer-implemented method of claim 5, comprising: generating and outputting a cryptographically signed certificate to the first user device for confirming that the secure virtual meeting vault is implemented in the TEE.

8. The computer-implemented method of claim 1, wherein the avatar representing the first user remains visible in the shared virtual world while also present in the secure virtual meeting vault, wherein audio interactions between at least the first user and a second user during attendance in the secure virtual meeting vault is not provided to a platform that deploys the shared virtual world to thereby prevent eavesdropping on conversations conducted in the secure virtual meeting vault, and comprising: outputting, to the platform, a visual indication for incorporating in the shared virtual world to indicate that the first user is interacting in the secure virtual meeting vault.

9. The computer-implemented method of claim 1, comprising: causing at least one privacy-related feature to be used during use of the secure virtual meeting vault: wherein the privacy-related feature is selected from a group comprising: detecting and disabling a microphone of at least one user device, monitoring eye movements of the first user to ensure that only the first user is using the first user device, and kicking a user device from the secure virtual meeting vault in response to a determination that an unauthorized microphone is being used by the first user device.

10. A computer program product, the computer program product comprising a computer readable storage medium having program instructions embodied therewith, the program instructions readable and/or executable by a computer to cause the computer to:
receive, by the computer from a first user device associated with a first user in a shared virtual world, a request to create a secure virtual meeting vault;
in response to receiving the request, create, by the computer, the secure virtual meeting vault, wherein the secure virtual meeting vault runs on a secured container computing environment that is separate from the shared virtual world;
teleport, by the computer, an avatar representing a first user in the shared virtual world to the secure virtual meeting vault; and
in response to a determination that an event within the secure virtual meeting vault has concluded, verifiably destroy, by the computer, the secure virtual meeting vault.

11. The computer program product of claim 10, the program instructions readable and/or executable by the computer to cause the computer to: record, by the computer, audio and/or video interactions between at least the first user and a second user during attendance in the secure virtual meeting vault.

12. The computer program product of claim 11, wherein verifiably destroying the secure virtual meeting vault includes: outputting the recording to a second user device associated with the second user, deleting the recording, and storing an indication of the recording and/or signatures of at least the first user and the second user to a predetermined location that is different than the user devices.

13. The computer program product of claim 12, wherein the predetermined location is a blockchain, and comprising: distributing a ledger of the blockchain to only the first user device and the second user device.

14. The computer program product of claim 10, wherein the secure virtual meeting vault is implemented in a trusted execution environment (TEE).

15. The computer program product of claim 14, wherein the TEE is a secure container.

16. The computer program product of claim 14, the program instructions readable and/or executable by the computer to cause the computer to: generate and output, by the computer, a cryptographically signed certificate to the first user device for confirming that the secure virtual meeting vault is implemented in the TEE.

17. The computer program product of claim 10, wherein the avatar representing the first user remains visible in the shared virtual world while also present in the secure virtual meeting vault, wherein audio interactions between at least the first user and a second user during attendance of the secure virtual meeting vault is not provided to a platform that deploys the shared virtual world to thereby prevent eavesdropping on conversations conducted in the secure virtual meeting vault, and comprising: outputting, to the platform, a visual indication for incorporating in the shared virtual world to indicate that the first user is interacting in the secure virtual meeting vault.

18. The computer program product of claim 10, the program instructions readable and/or executable by the computer to cause the computer to: cause, by the computer, at least one privacy-related feature to be used during use of the secure virtual meeting vault: wherein the privacy-related feature is selected from a group comprising: detecting and disabling a microphone of at least one user device, monitoring eye movements of the first user to ensure that only the first user is using the first user device, and kicking a user device from the secure virtual meeting vault in response to a determination that an unauthorized microphone is being used by the first user device.

19. A system, comprising:
a processor; and
logic integrated with the processor, executable by the processor, or integrated with and executable by the processor, the logic being configured to:
receive, from a first user device associated with a first user in a shared virtual world, a request to create a secure virtual meeting vault;
in response to receiving the request, create the secure virtual meeting vault, wherein the secure virtual meeting vault runs on a secured container computing environment that is separate from the shared virtual world;
teleport an avatar representing a first user in the shared virtual world to the secure virtual meeting vault; and
in response to a determination that an event within the secure virtual meeting vault has concluded, verifiably destroy the secure virtual meeting vault.

20. The system of claim 19, the logic being configured to: record audio and/or video interactions between at least the first user and a second user during attendance in the secure virtual meeting vault.
